(19) United States
(12) Patent Application Publication
(10) Pub. No.: US 2005/0262774 A1
(43) Pub. Date: Dec. 1, 2005

(54) Low cobalt carbide polycrystalline diamond compacts, methods for forming the same, and bit bodies incorporating the same

(76) Inventors: Ronald K. Eyre, Orem, UT (US); Nephi M. Mourik, Provo, UT (US)

Correspondence Address: CHRISTIE, PARKER & HALE, LLP, PO BOX 7068, PASADENA, CA, 91109-7068, US

(21) Appl. No.: 11/100,142

(22) Filed: Apr. 5, 2005

Related U.S. Application Data
(60) Provisional application No. 60/564,784, filed on Apr. 23, 2004.

(51) Int. Cl. B24D 3/00; C09K 3/14; C09C 1/68

(52) U.S. Cl. 51/307; 51/309

(57) ABSTRACT

A compact having a tungsten carbide substrate and an ultra hard material layer is provided. Also provided is a method of forming such a compact and a bit incorporating such compact. The compact tungsten carbide substrate has a lower content of cobalt than conventional compact substrates. The compact substrate may have tungsten carbide particles having a median particle size greater than conventional compact substrates.

### CROSS-REFERENCE TO RELATED APPLICATION

This application claims the benefit of U.S. Provisional Application No. 60/564,784, filed on Apr. 23, 2004, the contents of which are fully incorporated herein by reference.

### FIELD OF THE INVENTION

The present invention is generally related to compacts having carbide substrates having a lower cobalt content than conventional carbide substrates and a polycrystalline diamond layer, to a method of forming the same and to bit bodies incorporating the same.

### BACKGROUND OF THE INVENTION

Compacts such as cutting elements used in rock bits or other cutting tools typically have a body (i.e., a substrate), which has a contact or interface face. An ultra hard material layer is bonded to the contact face of the body by a sintering process to form a cutting layer. The substrate is generally made from tungsten carbide-cobalt (sometimes referred to simply as “cemented tungsten carbide,” “tungsten carbide” “or carbide”), while the ultra hard material layer is a polycrystalline ultra hard material, such as polycrystalline diamond (“PCD”).

Cemented tungsten carbide is formed by carbide particles being dispensed in a cobalt matrix, i.e., tungsten carbide particles are cemented together with cobalt. To form the substrate, tungsten carbide particles and cobalt are mixed together and then heated to solidify. To form a compact having an ultra hard material layer such as a PCD hard material layer, diamond crystals are mixed together and placed adjacent the cemented tungsten carbide body and subjected to a high temperature and high pressures so that inter-crystalline bonding between the diamond crystals occurs forming a polycrystalline ultra hard material diamond layer. Sometimes a mixture of diamond crystals and graphite can be used. Generally, a catalyst or binder material is added to the diamond particles to assist in inter-crystalline bonding. The process of heating under high pressure is known as sintering. Metals such as cobalt, iron, nickel, manganese and alike an alloys of these metals have been used as a catalyst matrix material for the diamond. Various other materials have been added to the diamond crystals, tungsten carbide being one example.

The cemented tungsten carbide may be formed by mixing tungsten carbide particles with cobalt and then heating to form the substrate. In some instances, the substrate may be fully cured. In other instances, the substrate may be not fully cured, i.e., it may be green. In such case, the substrate may fully cure during the sintering process. In other embodiments, the substrate maybe in powder form and may solidify during the sintering process used to sinter the ultra hard material layer.

Common problems that plague compacts having an ultra hard material layer, such as PCD layer bonded on a carbide substrate are chipping, spalling, partial fracturing, cracking or exfoliating or delamination of the PCD layer. These problems are often caused by the residual stresses generated on the interface between the diamond layer and the substrate during the sintering process. These problems result in the early failure of the ultra hard layer and thus, in a shorter operating life for the compact.

### SUMMARY OF THE INVENTION

Compacts such as cutting elements, methods of forming the same, and bit bodies incorporating the same are provided. In one exemplary embodiment, a compact is provided having a tungsten carbide substrate having less than 9% cobalt by weight and a polycrystalline ultra hard material, such as a diamond layer, formed over the substrate. In a further exemplary embodiment, the substrate has a cobalt content in the range of about 5% to less than 9% by weight. In yet a further exemplary embodiment, the substrate has no greater than about 6% by weight cobalt. In another exemplary embodiment, the tungsten carbide substrate has tungsten carbide particles having a median particle size from about 6 μm to about 9 μm. In another exemplary embodiment, the compacts are cutting elements mounted in a bit body. In yet another exemplary embodiment the ultra hard material layer interfaces with the substrate along a non-uniform interface.

In a further exemplary embodiment, a method for forming a compact such as a cutting element is provided. The method includes forming a substrate using tungsten carbide particles and less than 9% by weight cobalt, forming a diamond layer over the substrate forming an assembly, and sintering the assembly at a sufficient temperature and pressure to convert the diamond layer to a polycrystalline diamond layer. In a further exemplary embodiment, the method includes forming a substrate using cobalt in the range of about 5% to less than 9% by weight. In yet another exemplary embodiment, the method includes forming the substrate using no greater than about 6% cobalt by weight. In another exemplary embodiment, the tungsten carbide particles have a median particle size from about 6 μm to about 9 μm. In yet a further exemplary embodiment, the compact is a cutting element and the method further includes mounting the cutting element on an earth boring bit.

In another exemplary embodiment an earth boring bit is provided having a bit body having any of the aforementioned exemplary embodiment compacts or cutting elements mounted on the bit body. In one exemplary embodiment, the cutting element has a tungsten carbide substrate having less than 9% cobalt by weight. A polycrystalline diamond layer formed over the substrate. In another exemplary embodiment the cutting element tungsten carbide substrate has no greater than about 6% cobalt by weight. In another exemplary embodiment, the cutting element tungsten carbide substrate has tungsten carbide particles having a median particle size from about 6 μm to about 9 μm.

### BRIEF DESCRIPTION OF THE DRAWINGS

These and other features and advantages of the present invention will be better understood by reference to the following detailed description when considered in conjunction with the accompanying drawings wherein:

FIG. 1 is a perspective view of a conventional cutting element.

FIG. 2 is a graph of coefficient thermal expansion versus diamond volume fraction for diamond material layer.

FIG. 3 is a graph of coefficient of thermal expansion versus temperature for three tungsten carbide substrates having 5%, 10% and 15% cobalt content by weight, respectively.

FIG. 4 is a graph of elongation versus temperature for three tungsten carbide substrates having 5%, 10% and 15% cobalt content by weight, respectively.

FIG. 5 is a distribution graph of fracture toughness versus wear number for various grades of tungsten carbides.

FIGS. 6A, 7A, and 8A are graphs of stress versus location along a diamond surface for two different grades of tungsten carbide substrates.

FIGS. 6B, 7B, and 8B are cross-sectional views of half a shear cutter type of cutting element having a non-planar interface and serving as the legend for FIGS. 5A, 6A, and 7A, respectively.

FIG. 9 is a perspective view of a bit body incorporating cutting elements type compacts of the present invention.

### DETAILED DESCRIPTION OF THE INVENTION

This invention relates to compacts, as for example cutting elements such as shear cutters used in various cutting tools such as a drag bit. These compacts have a polycrystalline diamond (“PCD”) ultra hard material layer formed over a substrate where the substrate has a lower cobalt content than conventional compact substrates. This invention also relates to a method for forming such compacts. Moreover, the present invention relates to a bit such as a drag bit incorporating cutting elements made according to the principles of the present invention. For illustrative purposes, the present invention is described in relation to a cylindrical shear cutter type of compact.

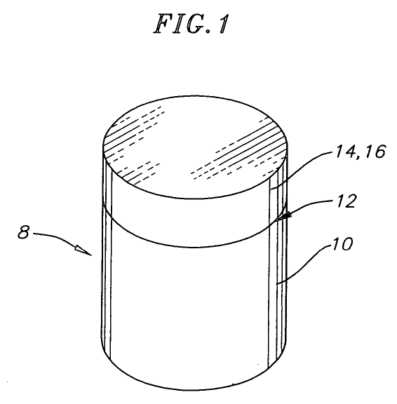

An exemplary shear cutter 8 as shown in FIG. 1, has a cylindrical tungsten carbide body 10 which has an interface or end surface 12 which may be uniform as for example shown in FIG. 1 or non-uniform as for example shown in FIGS. 6B, 7B and 8B. It should be noted that only half of a shear cutter divided along its central axis 31 is shown in FIGS. 6B, 7B, and 8B. An ultra hard material layer 14, such as polycrystalline diamond is bonded onto the interface 12 and forms a cutting layer 16 of the cutting element. The term “substrate” as used herein may mean any substrate over which is formed the ultra hard material layer. For example a “substrate” as used herein may be a transition layer formed over another substrate.

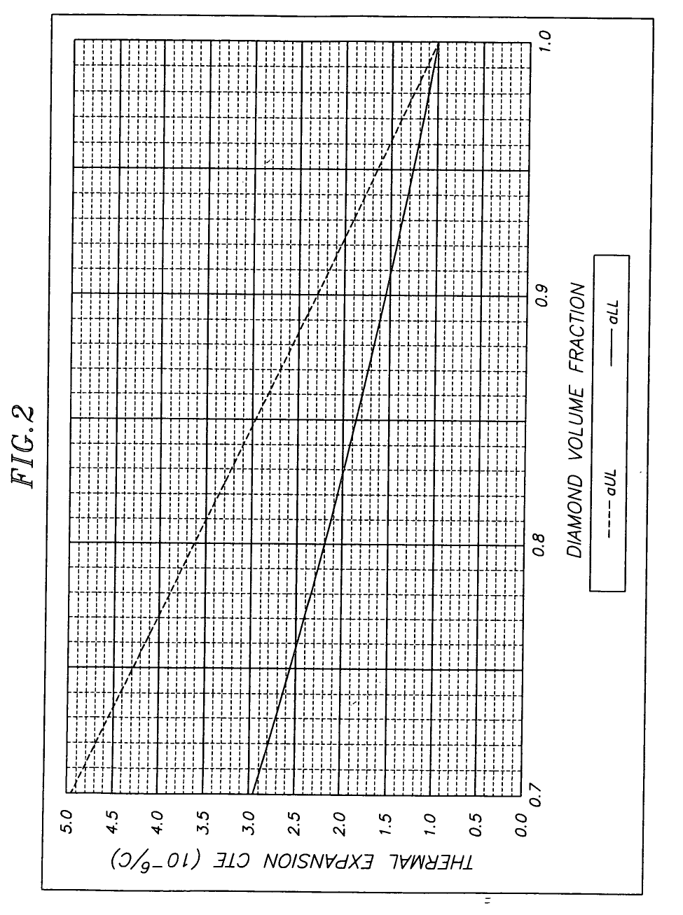

Residual stresses are generated at the interface between the ultra hard material layer and the substrate during sintering. Applicants have discovered that these residual stresses are due to coefficient of thermal expansion (“CTE”) mismatch and thus, an elongation mismatch, between the PCD ultra hard material layer and the substrate during cooling from the sintering process when the PCD ultra hard material layer bonds to the substrate. The PCD layer has a lower CTE than the tungsten carbide substrate. A typical PCD layer has a CTE typically in the range of about 1×10⁻⁶/° C. to about 5×10⁻⁶/° C., whereas conventional tungsten carbide substrates have a CTE of about 5.2×10⁻⁶/° C. to about 5.5×10⁻⁶/° C., when measured at room temperature. The CTE of a PCD layer is a function of the diamond volume fraction of the layer as for example shown in FIG. 2 where “aUL” denotes the CTE upper limit and “aLL” denotes the CTE lower limit.

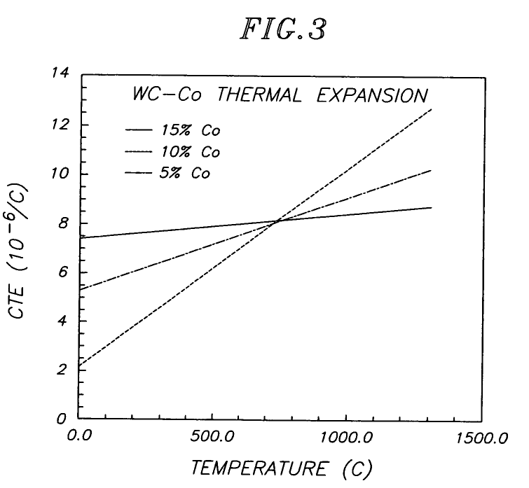

Applicants have discovered that by lowering the amount of cobalt used to form the substrate they can decrease the CTE of the substrate so that the difference between the CTE of the substrate and the CTE of the PCD is decreased. FIG. 3 depicts a graph of CTE versus temperature for tungsten carbide (WC-Co) substrates having cobalt contents of 15%, 10%, and 5%. FIG. 4 depicts a graph of percent elongation versus temperature for a tungsten carbide (WC—Co) substrate leaving cobalt contents of 15%, 10% and 5%. As can be seen from FIGS. 3 and 4, as the cobalt content decreases so does the CTE of the substrate at temperatures below about 700° C., and the elongation of the substrate.

Typically a cobalt content in excess of 9% and more likely between 9% and 16% by weight is used in forming the substrate. Applicants have discovered by using cobalt content less than 9% by weight, and in an exemplary embodiment in the range of about 5% to less than 9% by weight, they were able to sufficiently decrease the CTE of the substrate and reduce the residual stresses on the interface between the substrate and the PCD. In another exemplary embodiment, applicants expect to sufficiently reduce the CTE of the substrate by using between 6% and less than 9% by weight cobalt content in forming the substrate. In another exemplary embodiment, applicants expect to sufficiently reduce the CTE of the substrate by using not greater than about 6% cobalt by weight.

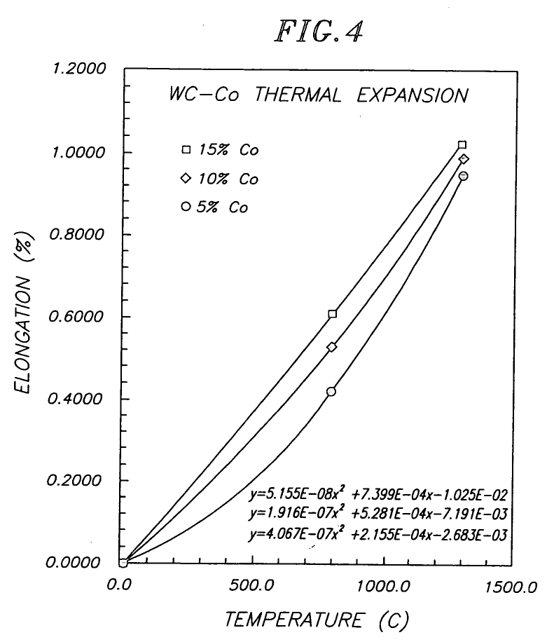

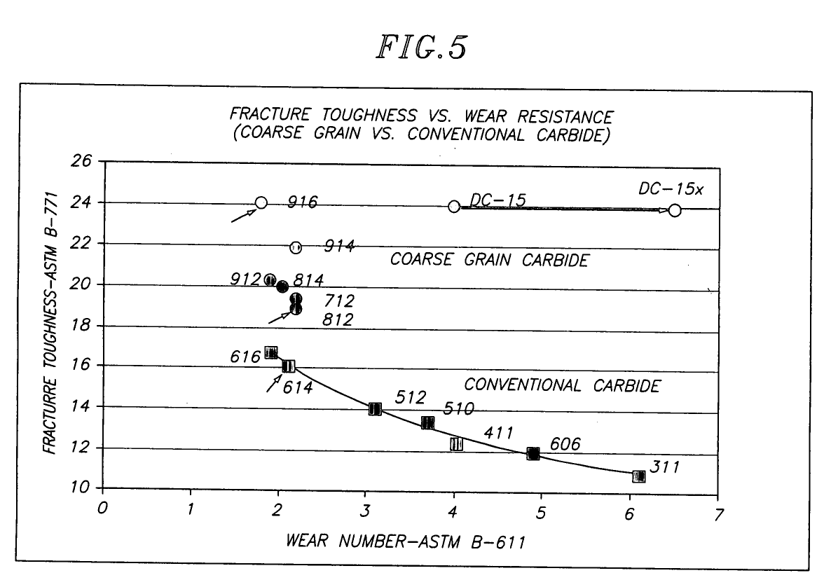

By decreasing the cobalt content in the substrate, the stiffness and the wear resistance of the substrate increases and the strength decreases. Conventional cutting elements and compacts have a substrate which is formed using tungsten particles which have an median size of about 4 μm. By forming the substrate using tungsten particles having a larger median size, and in an exemplary embodiment having a median size of about 6-9 μm, applicants have discovered that they can sufficiently increase the strength and fracture toughness of the substrate to overcome a decrease that is caused by a decrease in the cobalt content. Applicants' discovery is confirmed by FIG. 5 which shows a graph of the distribution of the fracture toughness vs. wear number, as determined in accordance with the ASTM B-611 specification, of various Smith International, Inc. grades of tungsten carbide substrates. The grades are three digit grades with the first digit denoting the median particle size of the tungsten carbide in μm and the second two digits denote the percentage of cobalt by weight forming the substrate. For example, a grade 614 tungsten carbide has a median particle size of 6 μm and a cobalt content of about 14% by weight. The median tungsten carbide particle size can be established by well known methods, as for example the ASTM E-112 method. As can be seen from FIG. 5, the fracture toughness and thus the strength of tungsten carbide increases as the median tungsten carbide particle size increases.

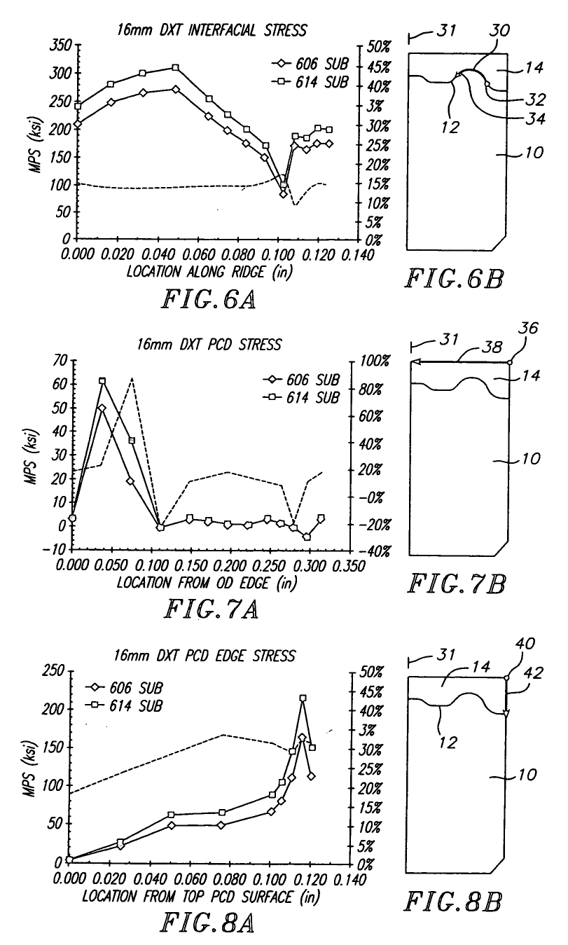

Applicants have also discovered by analysis, the results of which.are shown in FIGS. 6A, 7A, and 8A, that a 15% reduction in the maximum residual stresses is achieved when forming a cutting element with a substrate having a 6 μm median size tungsten carbide particles and 6% cobalt content by weight as compared to a cutting element formed with a 6 μm median size tungsten carbide particles and 14% cobalt content by weight. FIGS. 6A is a graph comparing interfacial stresses formed along a ridge 30 beginning at point 32 and moving along arrow 34 along the non-uniform interface surface 12 of substrate 10 shown in FIG. 6B. FIG. 7A is a graph comparing the residual stresses formed along the top surface of the PCD layer 14 beginning at point 36 at the edge of the PCD layer and moving radially inward along arrow 38, shown in FIG. 7B. FIG. 8A is a graph comparing residual stresses formed on the edge of the PCD layer 14 beginning at point 40 at the upper edge of the PCD layer and moving toward the substrate along arrow 42 shown in FIG. 8B. Furthermore, decreasing the cobalt content from 14% to 6% resulted in a substrate CTE decrease, measured at room temperature, from 5.48×10-6/° C. to 4.72×10-6/° C., which is a CTE decrease of about 14%.

Forming compacts such as cutting elements having substrates with reduced amounts of cobalt is contrary to conventional thinking where cutting elements are formed using higher cobalt content and where lower cobalt contents are avoided for fear of cobalt starvation of the substrates. In the present invention applicants have discovered that using 5% cobalt content by weight in forming a substrate is sufficient for preventing cobalt starvation of such substrate. Moreover, applicants have discovered that after sintering, the cobalt content by weight in the substrate is about the same as the cobalt content by weight used to form such substrate.

The exemplary compacts of the present invention may have planar, non-planar, uniform or non-uniform interfaces between their ultra hard material layer and substrate. As used herein, a “uniform” interface (or surface) is one that is flat or always curves in the same direction. This can be stated differently as an interface having the first derivative of slope always having the same sign. On the other hand, a “non-uniform” interface is defined as one where the first derivative of slope has changing sign. An example of a non-uniform interface is one that is wavy with alternating peaks and valleys, as for example shown in FIGS. 6B, 7B and 8B. Other non-uniform interfaces may have dimples, bumps, ridges (straight or curved) or grooves, or other patterns of raised and lowered regions in relief.

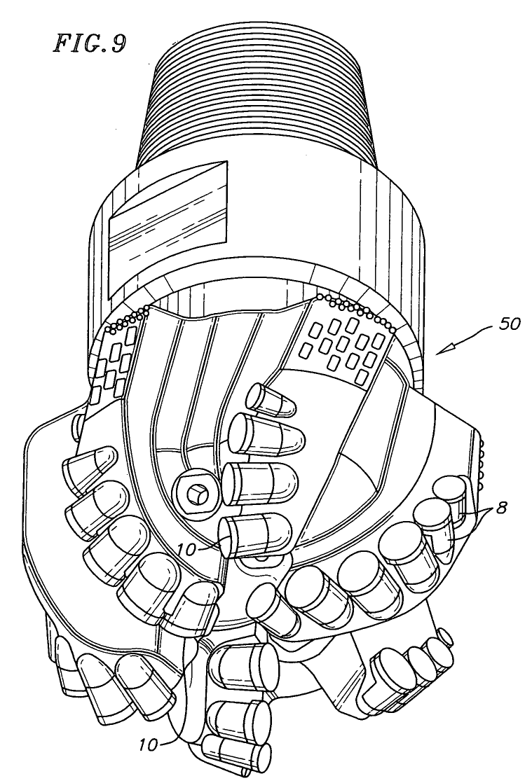

In an exemplary embodiment, any of the aforementioned exemplary embodiment substrates may be used to form a transition layer that is bonded to a substrate that may be of the conventional type or of an exemplary type as described herein. In other exemplary embodiments, any exemplary embodiment cutting element type compact may mounted on an earth boring bit 50, as for example shown in FIG. 9.

Exemplary embodiment compacts such as cutting elements of the present invention have reduced residual stresses on the interface between the ultra hard material layers and the substrates, while maintaining substrate toughness. This helps in reducing the onset of premature failure, as for example PCD layer delamination, chipping, spalling and fracturing during operation. More specifically, as the thermal mismatch between the PCD and the carbide substrate is reduced, the residual tensile stress in the cutting element as a whole is reduced. The resulting lower stressed cutting element is then able to withstand more aggressive loading conditions. In other words, the reduction in the thermal mismatch between the PCD and carbide results in a cutting element having increased burst strength. Burst strength is the cutting element's ability to withstand high load single or multiple impacts that are typically seen during drilling conditions. Furthermore, by reducing the cutting element's tensile residual stresses, the fracture toughness of the PCD is maintained or increased. These advantages overcome any decrease in the substrate strength that may be caused by the decrease in the cobalt content.

Although the present invention has been described and illustrated in respect to an exemplary embodiment, it is to be understood that it is not to be so limited, since changes and modifications may be made therein which are within the full intended scope of this invention as hereinafter claimed. For example, although the invention has been described in relation to a shear cutter type of cutting element, the invention equally applies to other types of compacts which may have uses in other tools such as other cutting tools such as roller cone bits, or other cutting tools besides bits.

1. A compact comprising:
a tungsten carbide substrate comprising less than 9% cobalt by weight and a carbide particle median size of not less than 6 μm; and
a polycrystalline diamond layer formed over the substrate.

2. A compact as recited in claim 1 wherein the substrate comprises cobalt in the range of about 5% to less than 9% by weight.

3. A compact as recited in claim I wherein the substrate comprises tungsten carbide particles having a median particle size in the range from about 6 μm to about 9 μm.

4. A compact as recited in claim 1 wherein the tungsten carbide substrate comprises cobalt in the range of about 6% to less than 9% by weight.

5. A compact as recited in claim 1 wherein the tungsten carbide substrate comprises cobalt in the range from about 5% to about 6% by weight.

6. A compact as recited in claim 1 wherein the tungsten carbide substrate comprises no greater than about 6% cobalt by weight.

7. A compact as recited in claim 6 wherein the substrate comprises tungsten carbide particles having a median particle size in the range from about 6 μm to about 9 μm.

8. A compact as recited in claim 1 wherein the compact is a cutting element for mounting on a earth boring bit body.

9. A compact as recited in claim 1 wherein the diamond layer interfaces with the substrate along a non-uniform interface.

10. A method for forming a compact comprising:
forming a substrate using less than 9% cobalt by weight and tungsten carbide particles having a median particle size not less than 6 μm;
forming a diamond layer over the substrate forming an assembly; and
sintering the assembly at a sufficient temperature and pressure to convert the diamond layer to a polycrystalline diamond layer.

11. A method as recited in claim 10 wherein forming comprises forming a substrate using cobalt in the range of about 5% to less than 9% by weight.

12. A method as recited in claim 10 wherein the tungsten carbide particles have a median particle size in the range from about 6 μm to about 9 μm.

13. A method as recited in claim 10 wherein the tungsten carbide substrate comprises cobalt in the range of about 6% to less than 9% by weight.

14. A method as recited in claim 10 wherein the tungsten carbide substrate comprises cobalt in the range from about 5% to about 6% by weight.

15. A method as recited in claim 10 wherein the tungsten carbide substrate comprises no greater than about 6% cobalt by weight.

16. A method as recited in claim 15 wherein the tungsten carbide particles have a median particle size from about 6 μm to about 9 μm.

17. A method as recited in claim 10 wherein the compact formed is a cutting element, the method further comprising mounting the cutting element on an earth boring bit body.

18. An earth boring drag bit comprising:
a drag bit body; and
a cutting element mounted on the bit body, the cutting element comprising,
a tungsten carbide substrate comprising less than 9% cobalt by weight, and
a polycrystalline diamond layer formed over the substrate.

19. A bit body as recited in claim 18 wherein the cutting element tungsten carbide substrate comprises no greater than about 6% cobalt by weight.

20. A bit body as recited in claim 18 wherein the cutting element tungsten carbide substrate comprises tungsten carbide particles having a median particle size from about 6 μm to about 9 μm.

21. A bit body as recited in claim 18 wherein the cutting element tungsten carbide substrate comprises tungsten carbide particles having a median particle size of not less than 6 μm.

22. A shear cutter comprising:
a tungsten carbide substrate comprising less than 9% cobalt by weight, and
a polycrystalline diamond layer formed over the substrate.
